(19) United States
(12) Patent Application Publication
(10) Pub. No.: US 2018/0225059 A1
(43) Pub. Date: Aug. 9, 2018

(54) OPERATING MODE MEMORY MIGRATION

(71) Applicant: Hewlett-Packard Development Company, L.P., Houston, TX (US)

(72) Inventors: Carlos Haas Costa, San Jose, CA (US); Christian S. Perone, Montreal (CA); Diego Rahn Medaglia, Porto Alegre (BR)

(21) Appl. No.: 15/749,431

(22) PCT Filed: Nov. 3, 2015
(86) PCT No.: PCT/US2015/058787

§ 371 Date: Jan. 31, 2018

(51) Int. Cl. G06F 3/06; G06F 12/10; G06F 12/06; G06F 12/02; G06F 13/16

(52) U.S. Cl. CPC G06F 3/0647; G06F 12/10; G06F 13/16; G06F 12/0246; G06F 12/06

(57) ABSTRACT

Examples include a system comprising a non-volatile memory and a volatile memory. Examples migrate system memory between the volatile memory and the non-volatile memory. After migration, examples translate virtual addresses to physical memory addresses corresponding to the volatile memory and/or non-volatile memory.

### BACKGROUND

For systems, such as personal computers, portable computing devices, servers, etc., various types of memory may be implemented for different purposes. Volatile memory may refer to a device/module that loses stored information upon removal of power from the device/module. Non-volatile memory may refer to a device/module that may store information even if power is removed from the device/module.

### DRAWINGS

FIG. 1A is a block diagram of an example system that may make use of the disclosure.

FIG. 1B is a block diagram of an example system that may make use of the disclosure.

FIG. 2 is a block diagram of an example system that may make use of the disclosure.

FIG. 3 is a block diagram of some components of an example system.

FIG. 4 is a block diagram of some components of an example system.

FIG. 5 is a flowchart that illustrates an example sequence of operations that may be performed by an example system to operate in example operating modes.

FIGS. 6A-B are flowcharts that illustrate example sequences of operations that may be performed by an example system to migrate a system memory.

FIG. 7 is a flowchart that illustrates an example sequence of operations that may be performed by an example system to determine an operating mode in which to operate.

FIG. 8 is a flowchart that illustrates an example sequence of operations that may be performed by an example system to transition to an example operating mode.

FIG. 9 is a flowchart that illustrates an example sequence of operations that may be performed by an example system to transition to an example operating mode.

FIG. 10 is a flowchart that illustrates an example sequence of operations that may be performed by an example system to transition to an example operating mode.

FIG. 11 is a flowchart that illustrates an example sequence of operations that may be performed by an example system to migrate system memory.

FIG. 12 is a flowchart that illustrates an example sequence of operations that may be performed by an example system to migrate system memory.

Throughout the drawings, identical reference numbers designate similar, but not necessarily identical, elements. Moreover the drawings provide examples and/or implementations consistent with the description; however, the description is not limited to the examples and/or implementations provided in the drawings.

### DESCRIPTION

Example computing systems may comprise at least one processing resource, a volatile memory, and a non-volatile memory. A computing system, as used herein, may include, for example, a personal computer, a portable computing device (e.g., laptop, tablet computer, smartphone), a server, blades of a server, a processing node of a server, a system-on-a-chip (SOC) computing device, a processing node of a SOC device, a smart device, and/or other such computing devices/systems. As used herein, a computing system may be referred to as simply a system.

Examples of volatile memory may comprise various types of random access memory (RAM) (e.g., SRAM, DRAM, DDR SDRAM, T-RAM, Z-RAM), as well as other memory devices/modules that lose stored information when powered off. Examples of non-volatile memory (NVM) may comprise read-only memory (ROM) (e.g., Mask ROM, PROM, EPROM, EEPROM, etc.), flash memory, solid-state memory, non-volatile state RAM (nvSRAM), battery-backed static RAM, ferroelectric RAM (FRAM), magnetoresistive RAM (MRAM), phase-change memory (PCM), magnetic tape, optical drive, hard disk drive, 3D cross-point memory (3D XPoint), programmable metallization cell (PCM) memory, silicon-oxide-nitride-oxide-silicon (SONOS) memory, resistive RAM (RRAM), domain-wall memory (DWM), nano-RAM, floating junction gate RAM (FJG RAM), memristor memory, spin-transfer torque RAM (STT-RAM), as well as other memory devices/modules that maintain stored information across power cycles (e.g., off/on). Non-volatile memory that stores data across a power cycle may also be referred to as a persistent data memory. As used herein, memory may comprise one device and/or module or a combination devices and/or modules. Furthermore, a memory device/module may comprise various components. For example, a volatile memory corresponding to a dynamic random-access memory (DRAM) module may comprise a plurality of DRAM integrated circuits, a memory controller, a capacitor, and/or other such components mounted on a printed circuit board. Similarly, a non-volatile memory may comprise a plurality of memory circuits, a memory controller, and/or other such components.

Furthermore, example systems may comprise a system memory, where the system memory refers to a portion of memory dedicated to storing current applications/programs/processes and data that are in use by the system. As will be appreciated, the system memory may store instructions for execution by a processing resource and data upon which the processing resource will operate when executing such instructions. Accordingly, system memory does not refer to a specific memory device or physical memory addresses, but rather system memory refers to a portion of dedicated memory that may be implemented in one or a plurality of memory devices.

In some example systems, a volatile memory may have lower read/write times when compared to non-volatile memory—i.e., volatile memory may have faster read/write speeds compared to non-volatile memory. As will be appreciated, faster read/write speeds for a memory may correspond to increases in processing resource efficiency. Therefore, for high-performance data processing operations with a system (e.g., faster processing speed, lower processing time), the system memory may be stored in a volatile memory. However, as discussed, data stored in volatile memory is not retained across a power cycle (i.e., when power is removed from the system then returned to the system). Therefore, for operation of a volatile memory, the system supplies power to the volatile memory to retain data stored in the volatile memory. For example, if the system is powered down, transitions to hibernation, etc., which may be referred to as transitioning to a lower-power mode, data stored in the volatile memory is not retained. Hence, if the system memory is stored in the volatile memory, the system memory may not be retained upon transition to an operating mode in which power is not supplied to the volatile memory or an operating mode in which a reduced amount of power is supplied to the volatile memory.

In contrast, if the system memory is stored in a non-volatile memory, the system memory may be retained across a power cycle. Therefore, the system may not supply power to a non-volatile memory when the non-volatile memory is not in use. Furthermore, an amount of power used in operating a non-volatile memory is relatively less than an amount of power used in operating a volatile memory. Therefore, if the system memory is implemented in a non-volatile memory, power consumption may be reduced. However, processing times may increase and processing speed may decrease. Hence, when the system memory is implemented in a non-volatile memory, a system may consume less power compared to a system implementing the system memory in volatile memory, but processing performance of the system may be lower compared to a system implementing the system memory in volatile memory.

Moreover, as compared to a volatile memory, non-volatile memory consumes less power during operation. In particular, during operation, volatile memory consumes power to store data—which may be referred to as power leakage. Non-volatile memory does not consume power to store data. Hence, during runtime non-volatile memory consumes power during read/write operations but not for maintaining stored data. Accordingly, during operation of a system, power consumption associated with a non-volatile memory corresponds to read and write operations (and the time associated with performing of such operations). In contrast, during operation of a system, power consumption associated with volatile memory corresponds to read and write operations in addition to power consumed for storing the data. Therefore, to operate in a lower power operating mode, a system may migrate system memory to a non-volatile memory, and the system may translate virtual addresses associated with the system memory to physical memory addresses of the non-volatile memory. As will be appreciated, by operating the system with the system memory in the non-volatile memory, examples may consume less power during operation as compared to power consumed when the system memory is implemented in volatile memory while the system is operating.

Accordingly, examples provided herein may migrate sections of system memory between volatile memory and non-volatile memory to facilitate operation of the system in different operating modes. For example, the system may migrate a system memory to a non-volatile memory such that the system may operate in a first operating mode, where the first operating mode may correspond to a low-power mode. As another example, the system may migrate the system memory to a volatile memory such that the system may operate in a second operating mode, where the second operating mode may correspond to a high-performance mode.

In some examples, a first section of the system memory may be stored in a non-volatile memory and a second section of the system memory may be stored in a volatile memory. In these examples, the system may operate in a third operating mode that may have lower power consumption and lower performance than a system in which the system memory is implemented in only volatile memory. Furthermore, in the third operating mode, the system may have higher power consumption and higher performance than a system in which the system memory is implemented in only non-volatile memory. In such examples, the system may migrate the first section to the non-volatile memory such that the system may reduce power supplied to some components of the volatile memory.

For example, the system may shut off power supplied to a DRAM module after migrating the sections of the system memory from the DRAM module to a non-volatile memory. In such examples, sections of system memory associated with higher priority applications and/or processes (e.g., operating system processes, graphics-related processes, user interactive applications, etc.) may be stored in volatile memory, while sections of system memory associated with lower-priority applications and/or processes (e.g., background processes, system maintenance applications, etc.) may be stored in non-volatile memory. In such examples, the third operating mode may facilitate operation of the system in a mode that balances power consumption and processing performance. While examples described herein include a first operating mode, a second operating mode, and a third operating mode, it will be appreciated that some examples may operate in more or less operating modes. In some examples, the various operating modes may correspond to power consumption and processing performance configurations in which the system may operate.

In examples, responsive to migration of sections of the system memory between the volatile memory and the non-volatile memory, page table entries may be updated to map virtual addresses associated with the sections of the system memory to corresponding physical memory addresses of the volatile memory and/or non-volatile memory to which the sections of system memory were migrated. Accordingly, virtual addresses associated with the system memory may be translated to corresponding physical memory addresses of the volatile memory and/or non-volatile memory. Therefore, during processing of instructions associated with an operating system, process, and/or application executing on the system, the system may translate virtual addresses associated with the system memory to corresponding physical memory addresses of the volatile memory and/or the non-volatile memory.

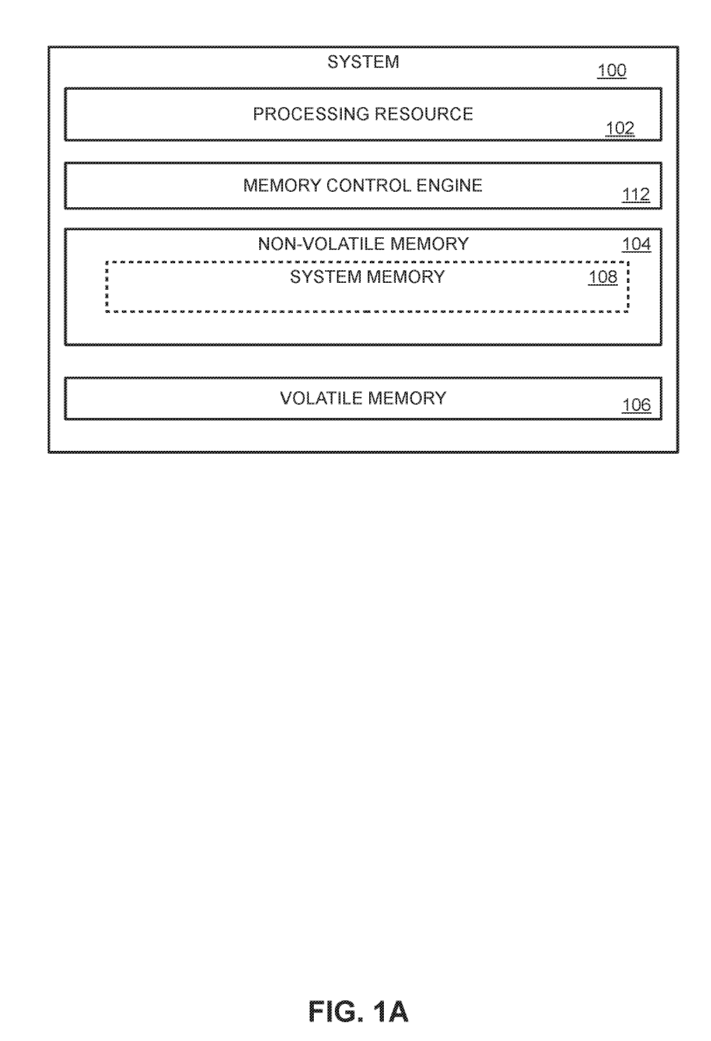

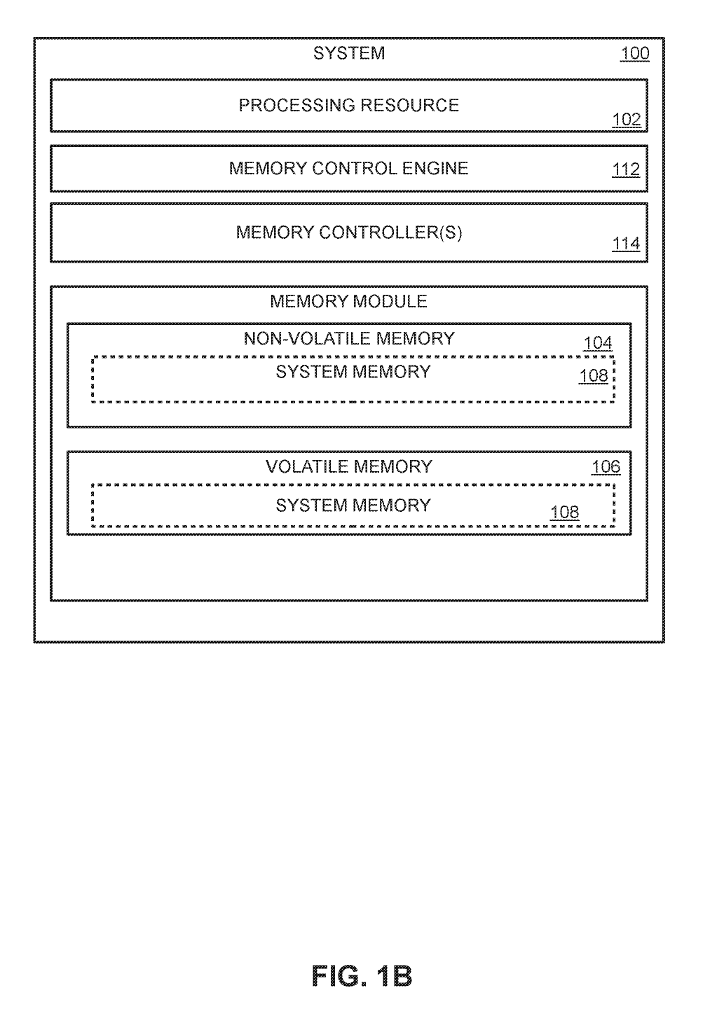

Turning now to the figures, and particularly to FIGS. 1A-B, these figures provide block diagrams that illustrate examples of a system 100. Examples of a system as disclosed herein include a personal computer, a portable electronic device (e.g., a smart phone, a tablet, a laptop, a wearable device, etc.), a workstation, a smart device, server, a processing node of a server, a data center comprising a plurality of servers, and/or any other such data processing devices. In the examples of FIGS. 1A and B, the system 100 comprises a processing resource 102, a non-volatile memory 104, and a volatile memory 106.

In the examples described herein, a processing resource 102 may include at least one hardware-based processor. Furthermore, the processing resource 102 may include one processor or multiple processors, where the processors may be configured in a single system 100 or distributed across multiple systems connected locally and/or remotely. As will be appreciated, a processing resource 102 may comprise one or more general purpose data processors and/or one or more specialized data processors. For example, the processing resource 102 may comprise a central processing unit (CPU), a graphics processing unit (GPU), an application-specific integrated circuit (ASIC), and/or other such configurations of logical components for data processing. In some examples, the processing resource 102 comprises a plurality of computing cores that may process/execute instructions in parallel, synchronously, concurrently, in an interleaved manner, and/or in other such instruction execution arrangements.

Volatile memory, as used herein, may comprise memory modules/devices that include random access memory (RAM) as well as other memory modules/devices, such as cache memory of processing resources, etc. The non-volatile memory may comprise modules/devices that persist data across a power cycle. In some examples, the non-volatile memory correspond to a class of non-volatile memory which is referred to as storage class memory (SCM). In these examples, the SCM non-volatile memory is byte-addressable, synchronous with a processing resource, and in a processing resource coherent domain. Moreover, SCM non-volatile memory may comprise types of memory having relatively higher read/write speeds as compared to other types of non-volatile memory, such as hard-drives or magnetic tape memory devices. Examples of SCM non-volatile memory include some types of flash memory, RRAM, memristors, PCM, MRAM, STT-RAM, as well as other types of higher read/write speed persistent data memory devices. As will be appreciated, due to relatively low read and write speeds of some types of non-volatile memory, such as spin-disk hard drives, NAND flash, magnetic tape drives, processing resources may not directly process instructions and data with these types of non-volatile memory. However, a processing resource may process instructions and data directly with a SCM non-volatile memory.

In FIGS. 1A-B, the non-volatile memory 104 includes a system memory 108 stored therein. FIG. 1B illustrates an example where at least some sections of the system memory 108 stored in the non-volatile memory 104 have been migrated to the volatile memory. Migration of the system memory 108 may comprise copying the data of the system memory of the non-volatile memory 104 to the volatile memory 106 as well as copying data of the system memory of the volatile memory 106 to the non-volatile memory 104. As will be appreciated, such migration may be done in sections and the migration may be a background and/or low-priority process that is performed while the system 100 continues execution of operating system instances, applications, and/or processes. The system 100 further comprises a memory control engine 112, where the memory control engine 112 migrates the system memory 108 to the non-volatile memory 104 prior to the system transitioning to a first operating mode. In FIG. 1B, the system 100 further includes at least one memory controller 114. Furthermore, a memory controller 114 corresponds to hardware components that control the reading and writing of data to memory (such as the non-volatile memory 104 and/or the volatile memory 106). In some examples, a memory controller 114 may be implemented in a processing resource, such as a central processing unit. In other examples, a memory controller may be implemented as a stand-alone component of a system. In some examples, a memory controller 114 may be implemented in a memory module.

While not shown in FIGS. 1A-B, for interface with a user or operator, some example systems may include a user interface incorporating one or more user input/output devices, e.g., one or more buttons, a display, a touchscreen, a speaker, etc. The user interface may therefore communicate data to the processing resource and receive data from the processing resource. For example, a user may input one or more selections via the user interface, and the processing resource may cause data to be output on a screen or other output device of the user interface. Furthermore, the system may comprise a network interface device. As will be appreciated, the network interface device comprises one or more hardware devices to communicate data over one or more communication networks, such as a network interface card. In addition, the system 100 may comprise applications, processes, and/or operating systems stored in a memory, such as the non-volatile memory 104. The applications, processes, ad/or operating systems may be executed by the system such that the processing resource 102 processes instructions of the applications, processes, and/or operating systems with the system memory stored in the non-volatile memory 104 and/or the volatile memory 106.

Furthermore, example systems, such as the example system of FIGS. 1A-B, may comprise engines, where such engines (such as the memory control engine 112) may be any combination of hardware and programming to implement the functionalities of the respective engines. In some examples described herein, the combinations of hardware and programming may be implemented in a number of different ways. For example, the programming for the engines may be processor executable instructions stored on a non-transitory machine-readable storage medium and the hardware for the engines may include a processing resource to process and execute those instructions.

In some examples, a system implementing such engines may include the machine-readable storage medium storing the instructions and the processing resource to process the instructions, or the machine-readable storage medium may be separately stored and accessible by the system and the processing resource. In some examples, engines may be implemented in circuitry. Moreover, processing resources used to implement engines may comprise at least one central processing unit (CPU), a graphics processing unit (GPU), an application specific integrated circuit (ASIC), a specialized controller (e.g., a memory controller) and/or other such types of logical components that may be implemented for data processing.

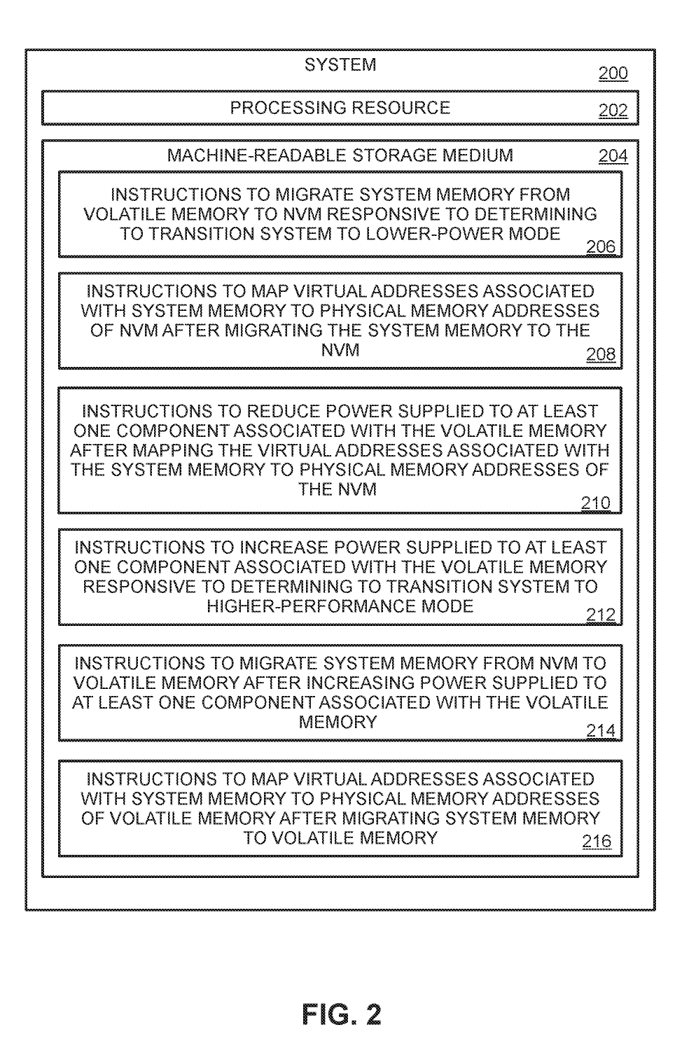

FIG. 2 provides a block diagram that illustrates an example system 200. In this example, the system 200 comprises at least one processing resource 202 and a machine readable storage medium 204. The machine-readable storage medium 204 may represent the random access memory (RAM) devices comprising the main storage of the example system 100, as well as any supplemental levels of memory, e.g., cache memories, non-volatile or backup memories (e.g., programmable or flash memories), read-only memories, etc. In addition, machine-readable storage medium 204 may be considered to include memory storage physically located elsewhere, e.g., any cache memory in a microprocessor, as well as any storage capacity used as a virtual memory, e.g., as stored on a mass storage device or on another system in communication with the example system 200. Furthermore, the machine-readable storage medium 204 may be non-transitory. In some examples, the machine-readable storage medium 204 may be a compact disk, blu-ray disk, or other such types of removable media. In some examples, the processing resource 202 and machine-readable storage medium 204 may correspond to processing units and memory devices arranged in at least one server. In other examples, the processing resource 202 and machine-readable storage medium may be arranged in a system-on-a-chip device. In some examples, the processing resource 202 and machine-readable storage medium may be arranged in a portable computing device, such as laptop, smart phone, tablet computer, etc.

In addition, the machine-readable storage medium 204 may be encoded with and/or store instructions that may be executable by the processing resource 202, where execution of such instructions may cause the processing resource 202 and/or system 200 to perform the functionalities, processes, and/or sequences of operations described herein. In the example of FIG. 2, the machine-readable storage medium 204 comprises instructions to migrate a system memory from a volatile memory to a non-volatile memory (NVM) responsive to determining to transition the system to a lower-power mode 206. In addition, the machine-readable storage medium 204 comprises instructions to map virtual addresses associated with the system memory to physical memory addresses of the non-volatile memory after migrating the system memory to the non-volatile memory 208. The machine-readable storage medium 204 also comprises instructions to reduce power supplied to at least one component associated with the volatile memory after mapping the virtual addresses associated with the system memory to physical memory addresses of the non-volatile memory 210.

Furthermore, the machine-readable storage medium 204 comprises instructions to increase power supplied to at least one component associated with the volatile memory responsive to determining to transition the system to a higher-performance mode 212. The machine-readable storage medium 204 further comprises instructions to migrate the system memory from the non-volatile memory after increasing power supplied to the at least one component associated with the volatile memory 214. The machine-readable storage medium 204 also comprises instructions to map virtual addresses associated with the system memory to physical memory addresses of the volatile memory after migrating the system memory to the volatile memory 216.

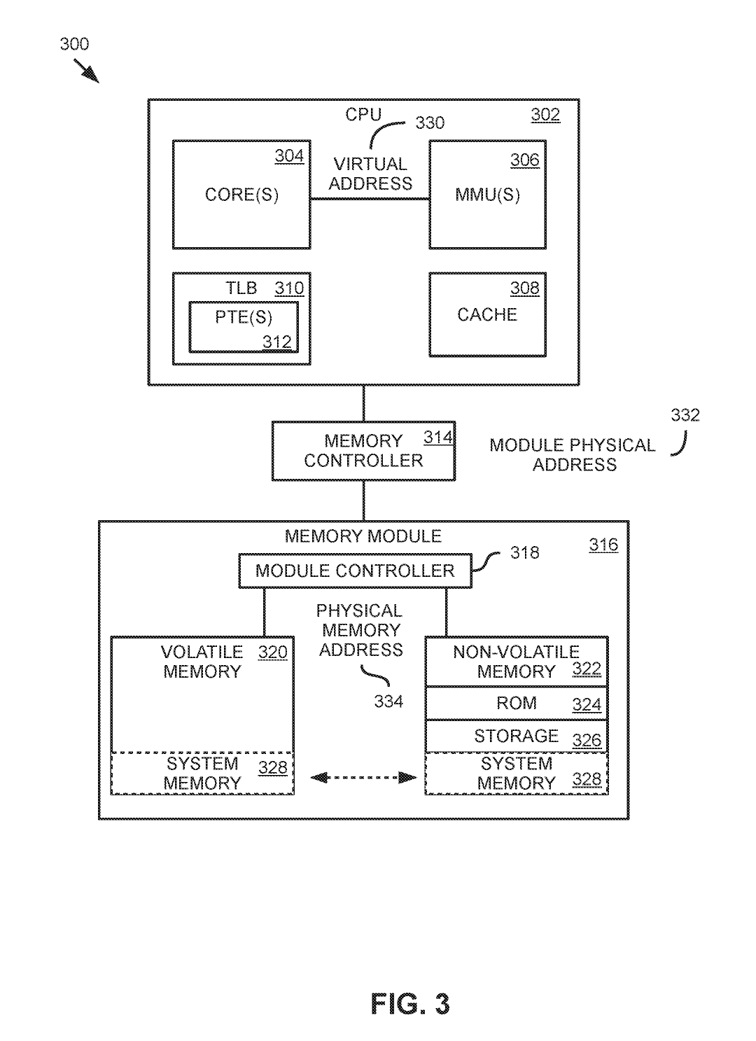

FIG. 3 provides a block diagram that illustrates some components of an example system 300. As discussed, in some examples, a processing resource comprises a central processing unit (CPU), and in this example, the system 300 comprises a CPU 302 that includes at least one core 304. In some examples, the CPU 302 may comprise one core 304, and in other examples the CPU 302 may comprise two cores 304 (referred to as a dual-core configuration), four cores (referred to as a quad-core configuration), etc. As shown, the CPU 302 further comprises at least one memory management unit (MMU) 306. In some examples, the CPU 302 comprises at least one MMU 306 for each core 304. In addition, in this example, the CPU comprises cache memory 308, where the cache memory 308 may comprise one or more cache memory levels that may be used for storing decoded instructions, fetched data, and results. Furthermore, the CPU 302 comprises at least one translation look-aside buffer (TLB) 310 that includes page table entries (PTEs) 312.

A translation look-aside buffer may correspond to a cache specially purposed for facilitating virtual address translation. In particular the TLB stores page table entries that map virtual addresses to an intermediate addresses and/or physical memory addresses. A memory management unit 306 may search a TLB with a virtual address to determine a corresponding intermediate address and/or physical memory address. A TLB is limited in size, such that not all necessary PTEs may be stored in the TLB. Therefore, in some examples additional PTEs may be stored in other areas of memory, such as a volatile memory and/or a non-volatile memory. As will be appreciated, the TLB represents a very high-speed memory location, such that address translations performed based on data stored in a TLB will be faster than translations performed with PTEs located elsewhere.

In this example, the CPU 302 is connected to a memory controller 314, and in turn, the memory controller 314 is connected to a memory module 316. The memory module 316 comprises a module controller 318, volatile memory 320, and non-volatile memory 322. As shown, the non-volatile memory 322 may comprise a portion associated with read-only memory (ROM) 324 and a portion associated with storage 326. As discussed previously, a system memory 328 may be stored in the volatile memory 320 and/or the non-volatile memory 322. For example, prior to transitioning to a lower-power operating mode, the system 300 may copy the system memory 328 from the volatile memory 320 to the non-volatile memory 322, and the system 300 may reduce or completely shut off power supplied to components associated with the volatile memory 320. As another example, prior to transitioning to a higher-performance operating mode, the system 300 may increase and/or turn on power supplied to components of the volatile memory 320, and the system 300 may migrate the system memory 328 stored in the non-volatile memory 322 to the volatile memory 320. During migration of the system memory 328, the system 300 may continue processing instructions using an instance of the system memory in the non-volatile memory 322 or volatile memory 320.

As will be appreciated, the cores 304 of the CPU 302 perform operations to implement an instruction cycle, which may also be referred to as the fetch-decode-execute cycle. As used herein, processing instructions may refer to performing the fetching, decoding, and/or execution of instructions and associated data. During the instruction cycle, the CPU 302 decodes instructions to be executed, where the decoded instructions include memory addresses for data upon which operations of the instruction are to be performed (referred to as source operands) as well as memory addresses where results of performing such operations are to be stored (referred to as target operands). As will be appreciated, the memory addresses of decoded instructions are virtual addresses. Moreover, a virtual address may refer to a location of a virtual address space that may be assigned to a process/application. A virtual address is not directly connected to a particular memory location of a memory device (such as the volatile memory 320 or non-volatile memory 322). Consequently, when preparing to execute an instruction, a core 304 may communicate a virtual address to an associated MMU 306 for translation to a physical memory address such that data stored at the physical memory address may be fetched for execution. A physical memory address may be directly related to a particular physical memory location (such as a particular location of the volatile memory 320 and/or non-volatile memory 322). Therefore, as shown in FIG. 3, at the core 304 level, memory addresses correspond virtual addresses 330.

The MMU 306 translates a virtual address to a physical memory address based on a mapping of virtual addresses to physical memory addresses that may be stored in one or more page table entries 312. As will be appreciated, in this example, the CPU 302 includes a TLB 310 that stores page table entries 312 with which the MMU 306 may translate a virtual address. In the example implementation illustrated in FIG. 3, the memory module 316 comprises both volatile memory 320 and the non-volatile memory 322. Therefore, in examples such as the example of FIG. 3, the virtual address is first translated to a module physical address 332. In other words, the system 300 does not directly translate the virtual address to the physical memory address, instead, the virtual address is translated to an intermediate address (which in this case is referred to as the module physical address). At the memory module 316, the module controller 318 may translate the module physical address 332 to a physical memory address 334, where the physical memory address 334 may correspond to a particular physical memory location of the volatile memory 320 or the non-volatile memory 322.

In examples similar to the example of FIG. 3, the system 300 may translate a virtual address 330 that is associated with the system memory 328 to a physical memory address 334 of the volatile memory 320 or the non-volatile memory 322. For example, if the system memory 328 is stored in the non-volatile memory 322, such as when the system is operating in a lower-power operating mode, the system translates a virtual address 330 associated with the system memory 328 to a corresponding physical memory address 334 of the non-volatile memory 322. As another example, if the system memory 328 is stored in the volatile memory 320, such as when the system 300 is operating in a higher-performance operating mode, the system 300 translates a virtual address associated with the system memory 328 to a physical memory address 334 of the volatile memory 320. As another example, if a first section of the system memory 328 is stored in the non-volatile memory 322 and a second section of the system memory 328 is stored in the volatile memory 320, such as when the system is operating in a balanced power/performance operating mode, the system 300 translates virtual addresses associated with the first section of the system memory 328 to physical memory addresses of the non-volatile memory 322, and the system 300 translates virtual addresses associated with the second section of the system memory 328 to physical memory addresses of the volatile memory 320.

Furthermore, in examples similar to the example of FIG. 3, where volatile memory 320 and non-volatile memory 322 may be implemented in a single memory module 316 with a module controller 318, migration of the system memory 328 from the non-volatile memory 322 to the volatile memory 320 may be performed at the memory module 316 level (i.e., without processing migration associated instructions with CPU 302 components). Furthermore, in examples in which the volatile memory 320 and non-volatile memory 322 are implemented in a single memory module 316 and where the read/write of data may be controlled by the module controller 318, it will be appreciated that a portion of the translation of a virtual address to a physical memory address may be performed by the module controller 318. In such examples, the module controller 318 controls whether a system memory 328 stored in the volatile memory 320 or the non-volatile memory 322 is used during processing of instructions. Furthermore, in some examples, a single memory controller 314 may be connected to the memory module 316 over a single channel. As will be appreciated, because the memory module 316 includes a module controller 318 memory access may be controlled by the module controller 318. In some examples similar to the example of FIG. 3, the memory module 316 may comprise a cache memory that may store page table entries, where the page table entries may map module physical addresses to physical memory addresses. In such examples, the module controller 318 may translate module physical addresses 332 to physical memory addresses 334 based at least in part on such page table entries stored at the memory module 316.

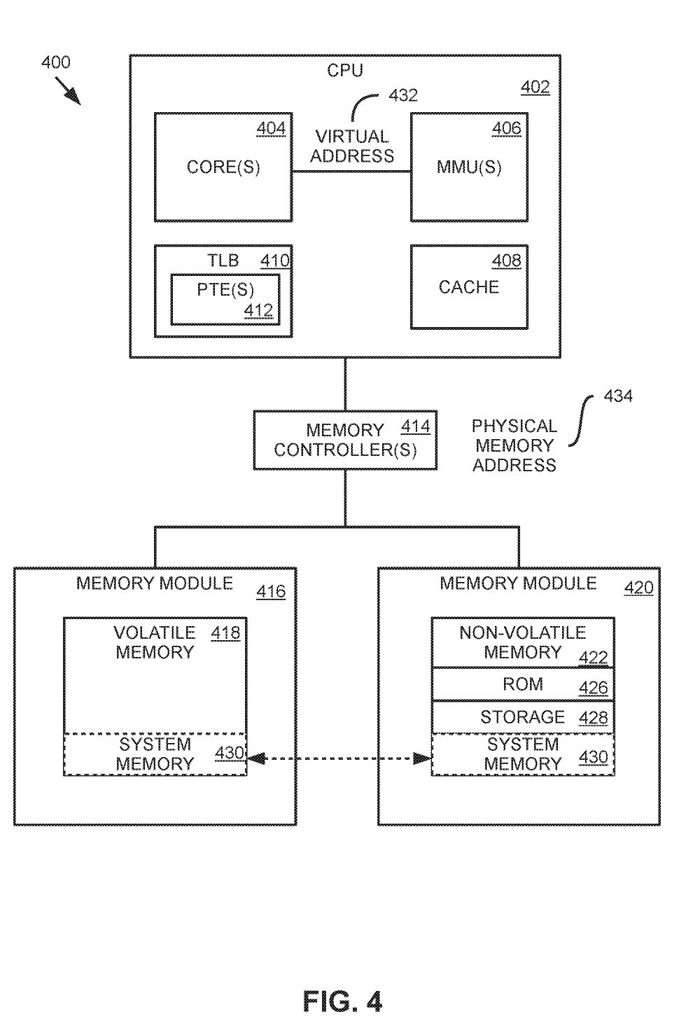

FIG. 4 provides a block diagram that illustrates some components of an example system 400. In this example, the system 400 comprises a CPU 402 that includes at least one core 404, a MMU 406 associated with each core 404. In addition, the CPU 402 comprises a cache memory 408 and a TLB 410, where the TLB 410 comprises PTEs 412 that may map virtual addresses to physical memory addresses. In the example system 400 of FIG. 4, the system 400 further comprises at least one memory controller 414, a first memory module 416 that comprises a volatile memory 418, and a second memory module 420 that comprises non-volatile memory 422. In some examples, the system 400 may comprise a memory controller 414 for each memory module 416, 420. In other examples, the system 400 may comprise a memory controller 414 that is connected to each memory module 416, 420 with a different channel. As shown, the non-volatile memory may also comprise a ROM 424 and storage 426.

In the example, the system 400 further comprises system memory 430 that may be stored in the non-volatile memory 422 and/or the volatile memory 430. In particular, when the system is operating in a first operating mode (which may correspond to a lower-power operating mode), the system memory 430 may be stored in the non-volatile memory 420. When the system 400 is operating in the first operating mode, the system 400 may process instructions using the system memory 430 stored in the non-volatile memory 422. While the system 400 is processing instructions using the system memory 430 stored in the non-volatile memory 422, the system may migrate the system memory 430 to the volatile memory 418. After migrating the system memory 430 to the volatile memory 418, the system may operate in a second operating mode (which may correspond to a higher-performance operating mode). In the second operating mode, the system 400 may process instructions using the system memory 430 stored in the volatile memory 418.

In some examples, a first section of the system memory 430 used in processing instructions may be in the non-volatile memory 422, and a second section of the system memory 430 used in processing instructions may be in the volatile memory 418. In such examples, power supplied to some components associated with the volatile memory 418 may be reduced. As such, processing performance and power consumption by the system 400 operating in the third operating mode may be relatively higher as compared to when the system 400 is operating in the second operating mode, and processing performance and power consumption may be relatively lower as compared to when the system 400 is operating in the first operating mode.

In this example, a respective core 404 communicates virtual addresses 432 to a respective MMU 406 for translation thereby. The respective MMU 406 translates the virtual address to a physical memory address 434. In some examples, a respective virtual address associated with the system memory 430 may be translated to a respective physical memory address of the volatile memory 418 or a respective physical memory address of the non-volatile memory 420. For example, when operating the system 400 in a lower-power operating mode, the system 400 may translate a virtual address 432 associated with the system memory 430 to a physical memory address 434 of the non-volatile memory. After migrating the system memory 430 from the non-volatile memory 422 to the volatile memory 418 to operate the system in a higher-performance operating mode, the system may translate a virtual address 432 associated with the system memory 430 to a physical memory address 434 of the volatile memory 418.

In examples similar to the example system 400 of FIG. 4, migration of the system memory 430 from the non-volatile memory 422 to the volatile memory 418 may be performed by processing instructions associated with the migration thereof. Similarly, copying the system memory 430 from the volatile memory 418 to the non-volatile memory 422 prior to transitioning to a lower-power mode may be performed by processing instructions associated with the copying thereof.

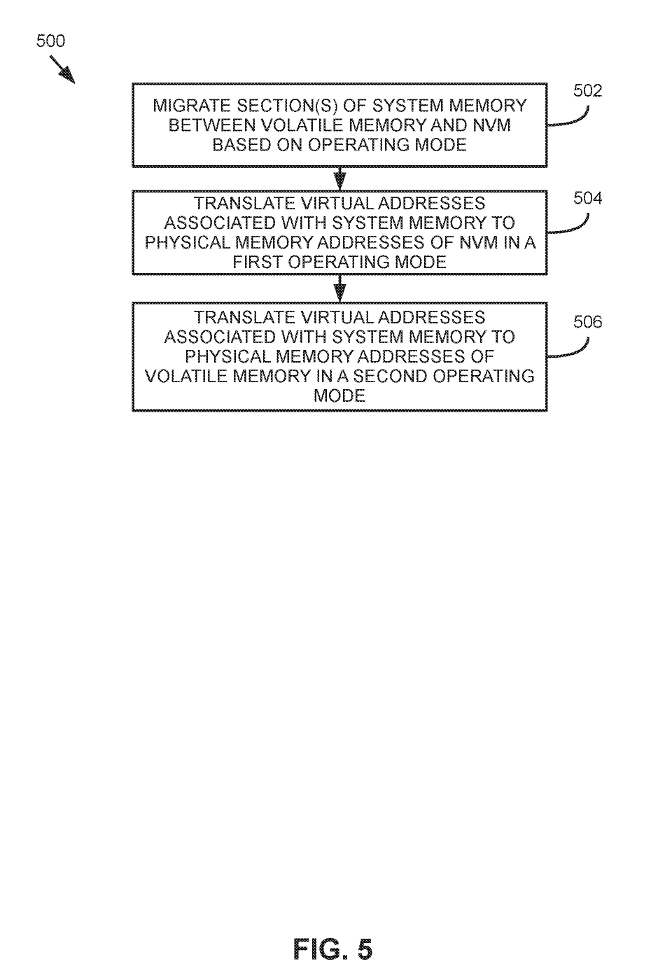

FIGS. 5-12 provide flowcharts that provide example sequences of operations that may be performed by an example system and/or a processing resource thereof to perform example processes and methods. In some examples, the operations included in the flowcharts may be embodied in a memory resource (such as the example machine-readable storage medium 204 of FIG. 2) in the form of instructions that may be executable by a processing resource to cause the system (e.g., the system 100 of FIGS. 1A-B, the system 200 of FIG. 2) to perform the operations corresponding to the instructions. Additionally, the examples provided in FIGS. 5-12 may be embodied in systems, machine-readable storage mediums, processes, and/or methods. In some examples, the example processes and/or methods disclosed in the flowcharts of FIGS. 5-12 may be performed by one or more engines implemented in a system.

Turning now to FIG. 5, this figure provides a flowchart 500 that illustrates an example sequence of operations that may be performed by an example system. As discussed previously, the system may migrate sections of a system memory between a volatile memory and a non-volatile memory based at least in part on an operating mode in which the system is determined to operate (block 502). The system may operate in different operating modes, where the different operating modes may correspond to power consumption and/or processing performance. In a first operating mode, the system may translate virtual addresses associated with the system memory to physical memory addresses of the non-volatile memory (block 504). In a second operating mode, the system may translate virtual addresses associated with the system memory to physical memory addresses of the volatile memory (block 506).

In examples similar to the example of FIG. 5, the sections of the system memory may be migrated between the volatile memory and the non-volatile memory during processing of instructions corresponding to applications, processes, and/or operating systems executing with the system. Furthermore, migration of sections of system memory may be performed responsive to initializing a transition between operating modes. For example, responsive to initializing a transition to a lower-power operating mode, the system may migrate the system memory to the non-volatile memory. After the system memory is migrated to the non-volatile memory, the system may translate virtual addresses associated with the system memory to physical memory addresses of the non-volatile memory where the system memory was migrated. As another example, responsive to initializing a transition to a higher-performance operating mode, the system may migrate the system memory to the volatile memory. After migrating the system memory to the volatile memory, the system may translate virtual addresses associated with the system memory to physical memory addresses of the volatile memory where the system memory was migrated. As will be appreciated, translating a virtual address to a physical memory address may comprise searching a page table entry based on the virtual address and with a controller (such as a memory management unit) to determine a physical memory address that is associated with a virtual address.

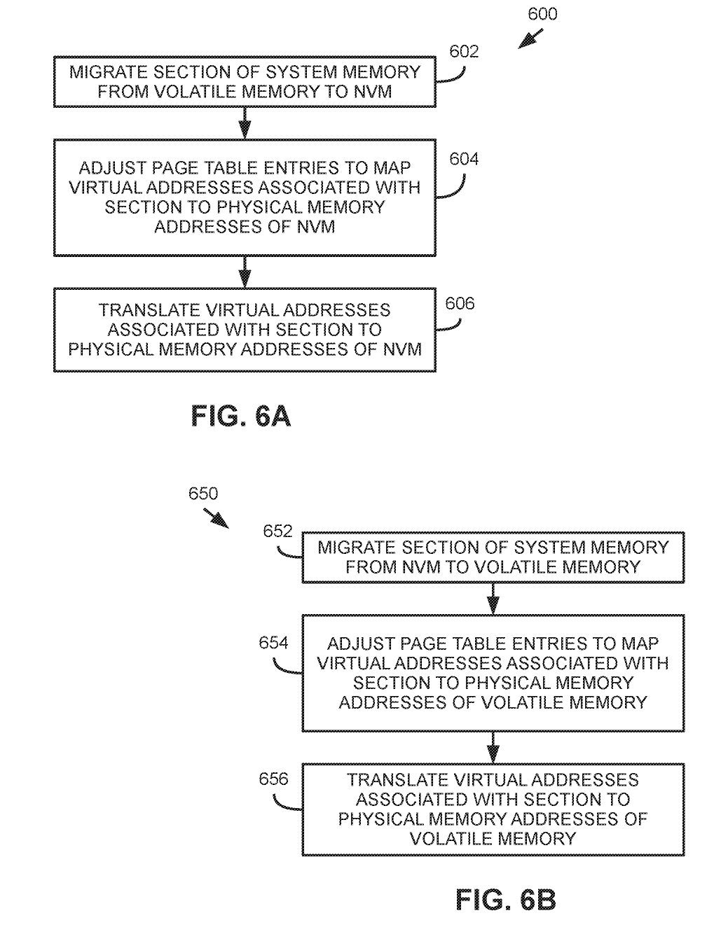

Turning now to FIG. 6A, this figure provides a flowchart 600 that illustrates an example sequence of operations that may be performed by a system. In this example, at least one section of system memory may be migrated from a volatile memory to a non-volatile memory (block 602). In some examples, all sections of the system memory may be migrated from the volatile memory to the non-volatile memory. In other examples, one section or some sections of the system memory may be migrated from the volatile memory to the non-volatile memory. After the at least one section is migrated from the volatile memory to the non-volatile memory, the system adjusts page table entries to map virtual addresses associated with the at least one section to physical memory addresses of the non-volatile memory (block 604). In some examples, the page table entries may be stored in a translation look-aside buffer. In some examples, the page table entries may be stored in other memory locations (e.g., the volatile memory, non-volatile memory, a high-speed buffer implemented in a memory module, etc.). After adjusting the page table entries to map the virtual addresses associated with the system memory to the non-volatile memory, the system translates virtual addresses associated with the at least one section of system memory to physical memory addresses of the non-volatile memory where the at least one section was migrated (block 606).

FIG. 6B provides a flowchart 650 that illustrates an example sequence of operations that may be performed by a system. In this example, at least one section of system memory is migrated from a non-volatile memory to a volatile memory (block 652). After the at least one section of system memory has been migrated from the non-volatile memory to the volatile memory, page table entries are adjusted to map virtual addresses associated with the at least one section to physical memory addresses of the volatile memory (block 654). Based on the adjusted page table entries, the system translates virtual addresses associated with the at least one section of system memory to physical memory addresses of the volatile memory (block 656).

Accordingly, as shown in the examples of FIGS. 6A-B, the system memory may be migrated between volatile and non-volatile memory, and the system may adjust mapping of virtual addresses and physical memory addresses based on the memory storing the system memory. With regard to the example of FIG. 6A, the system may migrate sections of the system memory to a non-volatile memory prior to transitioning to a lower-power operating mode. For example, after migrating sections of system memory from a volatile memory to a non-volatile memory, the system may reduce power supplied (e.g., power down, hibernate, reduce to a standby power level, etc.) to components associated with the volatile memory. In these examples, therefore, instructions of applications, processes, and/or operating systems executing on the system may be processed using the sections of the system memory stored in the non-volatile memory. Furthermore, with regard to the example of FIG. 6B, the system may migrate sections of the system memory from a non-volatile memory to a volatile memory prior to transitioning to a higher-performance operating mode.

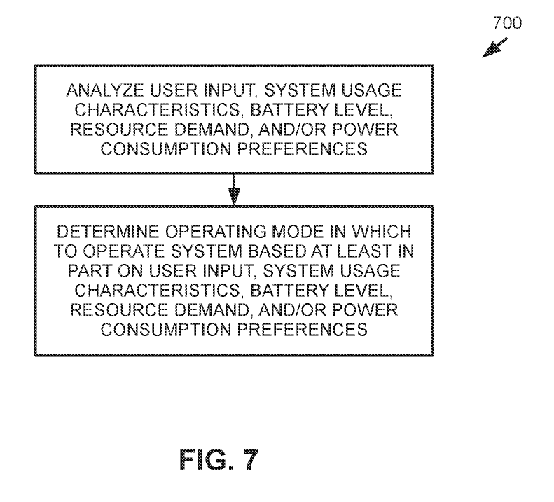

FIG. 7 provides a flowchart 700 that illustrates an example sequence of operations that may be performed by a system. As discussed, the system may comprise and/or be connected to one or more user interface devices. Furthermore, in some examples, the system may monitor resource usage of the system, resource demand, power consumption, and/or a battery level. In these examples, the system may analyze user input, system usage characteristics, battery level, resource demand, and/or power consumption preferences (block 702). The system may determine an operating mode in which to operate the system based at least in part on the user input, system usage characteristics, battery level, resource demand, and/or power consumption preferences (block 704).

For example, a user may interface with the system via a user interface device, and the system may monitor user input received via the user interface. In this example, a user may provide user input that indicates an operating mode in which the system is to operate, and the system may analyze the user input to determine the operating mode. For example, the user may provide user input that indicates that the system is to operate in a lower-power operating mode, and based on the user input, the system determines to operate in the lower-power operating mode.

As another example, the system may analyze system usage characteristics, where system usage characteristics may comprise characteristics about processing resources utilized, memory resources utilized, system workload processing characteristics. For example, system usage characteristics may indicate average processing cycles of each processing resource utilized at certain times during a day. As another example, system usage characteristics may indicate physical memory addresses utilized at certain times during a day. As another example, system usage characteristics may comprise processing and memory resources utilized during processing of a workload with the system. The system may analyze such system usage characteristics to determine an operating mode in which to operate the system.

For example, if the system usage characteristics indicate that the processing and/or memory resources of the system are highly utilized during a particular time period each day, the system may determine to operate the system in a higher-performance operating mode during the particular period. As will be appreciated, a highly utilized processing resource may refer to a relatively high use of processing cycles for the processing of instructions (e.g., 60% of processing cycles, 70% of processing cycles, 95% of processing cycles, etc.), and a highly utilized memory resource may refer to a relatively high ratio of memory locations (e.g., physical memory addresses) that are storing data in use (e.g., 60% of memory locations in active use, 70% of memory locations in active use, 95% of memory locations in active use, etc.). In this example, the system may increase power supplied to components associated with volatile memory of the system. The system may migrate system memory to the volatile memory, and the system may translate virtual addresses to physical memory locations of the volatile memory.

As another example, system usage characteristics may indicate that a relatively lower amount of processing and/or memory resources of the system are in use (i.e., relatively low utilization) during a particular period of a day. In this example, the system may determine to operate the system in a lower-power operating mode during the particular period. In this example, the system may migrate a system memory from a volatile memory to a non-volatile memory. The system may translate virtual addresses associated with the system memory to physical memory addresses of the non-volatile memory, and the system may reduce power supplied to some components associated with the volatile memory.

As another example, the system may be a portable computing device, such as a laptop computer, smart phone, tablet computer. The system may be powered with a battery. In this example, the system may monitor a remaining charge for the battery (referred to as a battery level), and the system may determine an operating mode for the system based on the battery level. For example, the system may operate in a first operating mode that corresponds to a low-power operating mode, a second operating mode that corresponds to a high-performance operating mode, and a third operating mode that corresponds to an intermediate power/performance operating mode (also referred to as a balanced power/performance operating mode).

In this example, the system may determine to operate in the first operating mode if the battery level is below a pre-defined threshold (e.g., 10% of full charge remaining, 20% of full charge remaining, 30% of full charge remaining, etc.). When the system determines to operate in the first operating mode, the system may migrate a system memory from a volatile memory to a non-volatile memory; translate virtual addresses associated with the system memory to physical memory addresses of the non-volatile memory; and reduce power supplied to components associated with the volatile memory.

Continuing the example, the system may determine to operate in the second operating mode if the battery level is above a pre-defined threshold (e.g., the battery level indicates the battery is fully charged, the battery level is above 80% of full charge remaining, etc.). When the system determines to operate in the second operating mode, the system may increase power supplied (e.g., power up, increase from a standby power supply level, etc.) to components associated with a volatile memory of the system (e.g., DRAM modules); migrate the system memory to the volatile memory from a non-volatile memory; and translate virtual addresses associated with the system memory to physical memory addresses of the volatile memory.

In addition, in this example, the system may determine to operate in the third operating mode if the battery level is in an approximate range between a predefined lower threshold for operating in the first operating mode and a predefined upper threshold for operating in the second operating mode. In this example, the system may migrate sections of the system memory to the non-volatile memory and/or the volatile memory to facilitate a processing speed and power consumption balance. In similar examples, the system may selectively supply power to some components associated with some volatile memory.

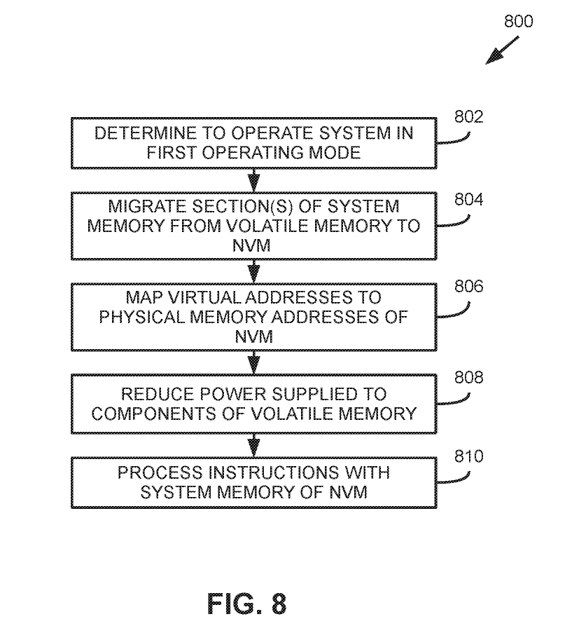

Turning now to FIG. 8, this figure provides a flowchart 800 that illustrates an example sequence of operations that may be performed by a system. In this example, the system determines to operate in a first operating mode (block 800). In some examples, the first operating mode may correspond to a low-power operating mode and/or a lower-power operating mode. The system migrates at least one section of system memory from a volatile memory to a non-volatile memory (block 804). As will be appreciated, in some examples, sections of system memory may be located in non-volatile memory prior to transitioning to the first operating mode. Therefore, sections in volatile memory may be migrated to the non-volatile memory as well. The system maps virtual addresses associated with the migrated sections of the system memory to physical memory locations of the non-volatile memory (block 806). As discussed, the first operating mode may correspond to a lower-power operating mode (e.g., the system consumes less power to operate). Therefore, after the sections of system memory have been migrated and the virtual addresses have been mapped to the physical memory locations of the non-volatile memory, the system may reduce power supplied to components associated with the volatile memory (block 808). In some examples, reducing power supplied to components associated with the volatile memory may comprise powering down components, reducing power supplied to a standby power level, etc. The system processes instructions with the system memory stored in the non-volatile memory (block 810). Furthermore, components associated with the volatile memory may comprise, for example, volatile memory modules, memory circuits, memory controllers, etc.

Accordingly, the example provided in FIG. 8 facilitates transition to a first operating mode in which the system memory is implemented in the non-volatile memory. As will be appreciated, storing the system memory in the non-volatile memory may facilitate reduction of power supplied to components associated with the volatile memory. For example, in a system comprising a volatile memory DRAM module and non-volatile memory, the system may migrate system memory from the DRAM module to the non-volatile memory, and the system may reduce power supplied to the DRAM module and/or power supplied to a memory controller associated with the DRAM module. In this example, power consumption of the system may be reduced. When the system is operating in the first operating mode, the system processes instructions for applications, processes, and/or operating systems executing on the system with the system memory implemented in the non-volatile memory.

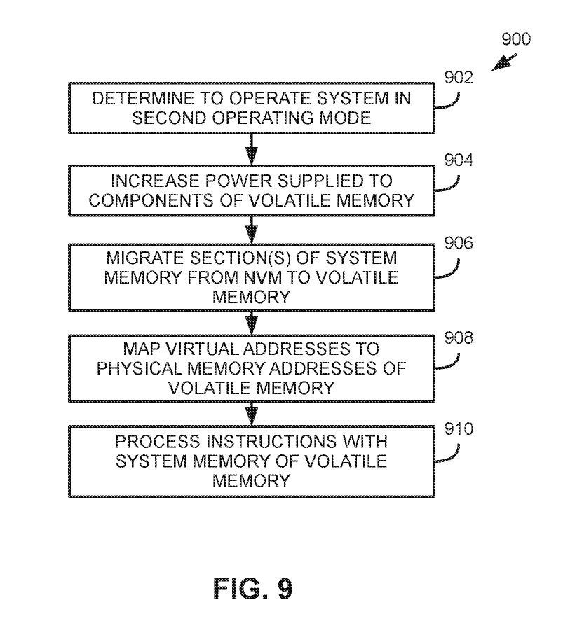

FIG. 9 provides a flowchart 900 that illustrates a sequence of operations that may be performed by a system. In this example, the system determines to operate in a second operating mode (block 902). In some examples, the second operating mode may correspond to a higher-performance operating mode. The system increases power supplied to components associated with a volatile memory (block 904). As will be appreciated, the power supplied to components associated with the volatile memory may be increased to an operational power level such that the volatile memory may be used by the system. The system migrates sections of the system memory from a non-volatile memory to a volatile memory (block 906), and the system maps virtual addresses associated with the migrated sections of the system memory to physical memory addresses of the volatile memory (block 908). After the sections of system memory are migrated and the virtual addresses associated with the sections are mapped to physical memory addresses of the volatile memory, the system processes instructions associated with applications, processes, and/or operating systems executing on the system with the system memory implemented in the volatile memory (block 910).

The examples provided in FIG. 9 facilitates transition to a second operating mode in which the system memory may be implemented in the volatile memory. As compared to the first operating mode, the second operating mode may consume more power during operation (due to use of the volatile memory), and the second operating mode may perform data processing operations in less time. Hence, the first operating mode, in which the system memory is implemented in the non-volatile memory may be referred to as a lower-power operating mode (or a low-power operating mode), and the second operating mode, in which the system memory is implemented in the volatile memory may be referred to as a higher-performance operating mode (or a high-performance operating mode). As will be appreciated, the terms “lower-power operating mode,” “low-power operating mode,” higher-power operating mode,” and “high-power operating mode” correspond to relative comparisons between the various operating modes in which the system may operate, where such relative comparisons correspond to power consumption and processing performance.

In examples similar to the example of FIG. 9, a system may perform data processing operations at higher speeds (and correspondingly lower processing times) due to faster read/write speeds associated with volatile memory. In examples similar to the example of FIG. 8, a system may perform data processing operations with lower power consumption due to lower power consumption characteristics associated with non-volatile memory. As discussed herein, the system may dynamically switch between operating modes, and the system may dynamically migrate sections of system memory between volatile memory and non-volatile memory based on the operating mode in which the system is to operate. Examples provided herein facilitate the transition in operating modes and migration of sections of system memory by adjusting a mapping of virtual addresses associated with sections of the system memory to physical memory address of the volatile memory and/or non-volatile memory. In such examples, adjustment of the mapping of virtual address to physical memory address facilitates translating virtual addresses associated with the system memory to physical memory addresses of the volatile memory and/or non-volatile memory.

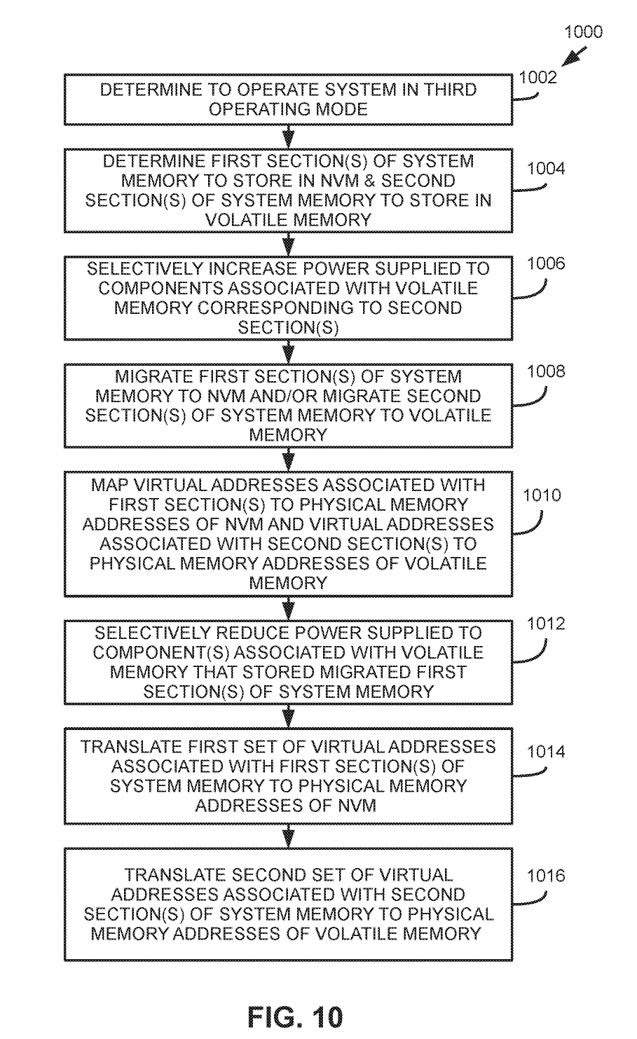

FIG. 10 provides a flowchart 1000 that illustrates an example sequence of operations that may be performed by a system. In this example, the system determines to operate in a third operating mode (block 1002). In some examples, the third operating mode may correspond to an operating mode that facilitates higher data processing performance than a low-power operating mode and lower power consumption than a high-performance operating mode—i.e., the third operating mode may balance power consumption and data processing performance.

In this example, the system determines sections of system memory to be stored in non-volatile memory, which may be referred to as first sections, and the system determines sections of the system memory to be stored in volatile memory (block 1004). In some examples, the system determines sections of system memory to store in the non-volatile memory and/or the volatile memory based at least in part a priority associated with applications, processes, and/or operating systems to which such sections of system memory are assigned. In addition, the system may determine sections of system memory to store in the non-volatile memory and/or the volatile memory based at least in part on components associated with the volatile memory.

For example, if a particular section of system memory corresponds to a low-priority background process, the system may determine that the particular section of system memory is to be stored in non-volatile memory. In this example, the low priority of the process reflects that fast data processing is not needed for the process. Hence, the system may determine that the particular section of system memory corresponding to the low-priority background process may be implemented in non-volatile memory, such that power consumption may be reduced. As another example, if a particular section of system memory corresponds to a high-priority process (such as a graphics application, a real-time data processing application, etc.), the system may determine that the particular section is to be stored in volatile memory. In this example, the high priority of the process reflects that faster data processing may be needed for the process. Hence, the system may determine that the particular section of system memory corresponding to the high-priority process may be implemented in volatile memory, such that the faster read/write speeds of the volatile memory may be utilized.

As another example, a system may determine sections of system memory to store in the non-volatile memory and/or volatile memory based at least in part on components associated with the volatile memory. For example, if a particular section of system memory is implemented on a DRAM module (a volatile memory), the system may determine to store the particular section of system memory in non-volatile memory such that power supplied to the DRAM module may be decreased. As will be appreciated, while the above examples relate to a single factor for determining to store sections of system memory in the non-volatile memory or the volatile memory, other examples may determine to store sections of system memory in the non-volatile memory or the volatile memory based on such factors in combination. Furthermore, examples may determine sections of system memory in non-volatile memory or volatile memory based at least in part on other factors that may relate sections of system memory to power consumption and/or data processing performance.

The system selectively increases power supplied to components associated with the volatile memory that corresponds to the second sections (block 1006). For example, if the system determines that additional volatile memory is needed for storing second sections, or if the system is operating with components associated with the volatile memory powered down or in stand-by, the system increases power supplied to components associated with the volatile memory with which to store the second sections. As a particular example, if the system is operating in a lower-power operating mode, in which the system memory is implemented in non-volatile memory only and components associated with volatile memory are powered down, the system may increase power supplied to components associated with the volatile memory sufficient to store the second sections of system memory. For example, if the system comprises a plurality of modules of volatile memory that each are controlled by a separate memory controller, the system may only increase power supplied to a subset of volatile memory modules and the connected memory controllers. Furthermore, it will be appreciated, that in some examples, sufficient volatile memory may be available (i.e., supplied with an operational level of power) to store the section sections of system memory, in which case the system may not power up any additional components associated with the volatile memory.

The system may migrate the first sections of system memory to the non-volatile memory and the system may migrate the second sections of system memory to the volatile memory (block 1008). As will be appreciated, some sections of system memory of the first sections may already be stored in the non-volatile memory, and some sections of system memory of the second sections may already be stored in the volatile memory. In such cases, migration is not performed for such sections. Furthermore, sections of system memory of the first sections that are stored in the volatile memory may be migrated from the volatile memory to the non-volatile memory, and sections of system memory of the second sections that are stored in the non-volatile memory may be migrated from the non-volatile memory to the volatile memory. After migration, the system maps virtual addresses associated with the first sections that were migrated to the non-volatile memory to physical memory addresses of the non-volatile memory, and the system maps virtual addresses associated with the second sections of system memory that were migrated to the volatile memory to physical memory addresses of the volatile memory (block 1010).

The system may selectively reduce power supplied to components associated with the volatile memory that stored first sections of system memory that were migrated to the non-volatile memory (block 1012). For example, if a volatile memory module only stores sections of system memory that were migrated, the system may power down the volatile memory. As will be appreciated, in some examples, components may be associated with volatile memory storing second sections of system memory (i.e., sections of system memory still in use by the system) such that after migration, the power supplied to such components may not be reduced. For example, if a memory controller controls a first volatile memory module and a second volatile memory module, and the first volatile memory module stored first sections of system memory that were migrated and no other sections in use by the system, the system may reduce power supplied to the first volatile memory module. However, if the second memory module stores second sections of system memory (i.e., sections of system memory in use by the system), the system may not reduce power supplied to the memory controller.

After migrating the sections of the system memory to the non-volatile memory and/or the volatile memory and mapping virtual addresses associated with migrated sections to corresponding physical memory addresses of the non-volatile memory and volatile memory, the system translates a first set of virtual addresses associated with the first sections of system memory to physical memory addresses of the non-volatile memory (block 1014), and the system translates a second set of virtual addresses associated with the second sections of system memory to physical memory addresses of the volatile memory (block 1016).

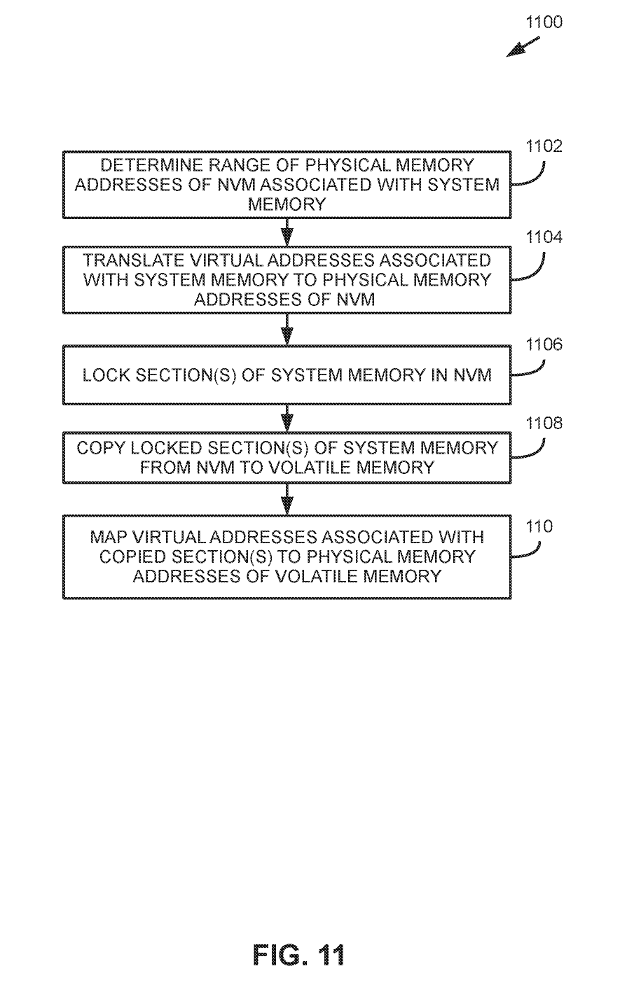

FIG. 11 provides a flowchart 700 that illustrates an example sequence of operations that may be performed by a system to migrate sections of system memory from a non-volatile memory to a volatile memory. The system may determine a range of physical memory addresses of a non-volatile memory associated with a system memory (block 1102). While the system memory is implemented in the non-volatile memory (i.e., before migration), the system may translate virtual addresses associated with the system memory to physical memory addresses of the range of physical memory addresses of the non-volatile memory (block 1104). In some examples, the system may migrate the system memory to a volatile memory in sections. As shown in this example, the system may lock at least one section of system memory in the non-volatile memory (block 1106). In such examples, locking a section of system memory prevents writing of data to the locked section. After locking the at least one section, the system may copy the at least one locked section of system memory from the non-volatile memory to the volatile memory (block 1108). Responsive to copying the locked sections of virtual memory to the volatile memory, the system may map virtual addresses associated with the copied at least one section of system memory to corresponding physical memory addresses of the volatile memory storing the copied at least one section (block 1110).

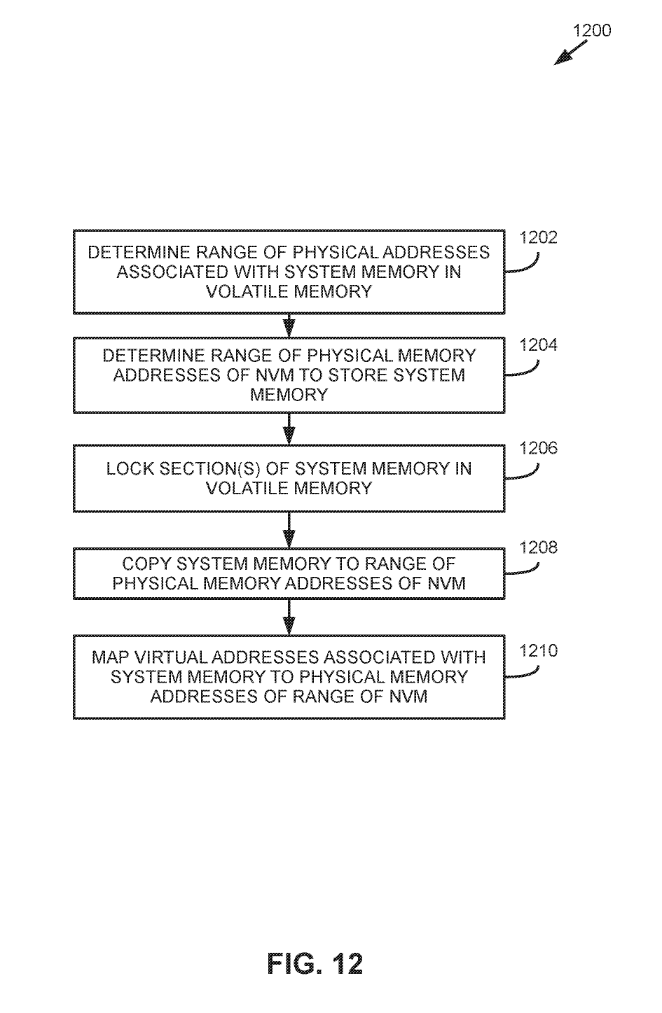

FIG. 12 provides a flowchart 1200 that illustrates an example sequence of operations that may be performed by a system to migrate system memory from a volatile memory to a non-volatile memory. The system may determine a range of physical memory addresses associated with system memory that is stored in the volatile memory (block 1202). The system determines a range of physical memory addresses of the non-volatile memory to store the system memory (block 1204). In some examples, the system may lock at least one section of system memory in the volatile memory (block 1206), and the system copies the data stored in the system memory of the volatile memory to the range of physical addresses of the non-volatile memory (block 1208). The system maps virtual addresses associated with the system memory to the range of physical memory addresses of the non-volatile memory (block 1210).

Therefore, examples of systems, processes, methods, and/or computer program products implemented as executable instructions stored on a non-transitory machine-readable storage medium described herein may migrate system memory between non-volatile memory resources and volatile memory resources according to various operating modes in which the system may operate. Example systems may implement system memory in non-volatile memory and reduce power supplied to components associated with volatile memory to facilitate a low power consumption operating mode (which may be referred to as a low-power operating mode and/or a lower-power operating mode). In addition, example systems may implement system memory in volatile memory to facilitate a high data processing performance operating mode (which may be referred to as a high-performance operating mode and/or a higher-performance operating mode). Furthermore, various implementations of system memory partially in volatile memory and non-volatile memory may facilitate a plurality of operating modes to facilitate various power consumption and data processing performance operating modes. For example, in a third operating mode, the system may migrate sections of system memory associated with low-priority processes/applications to non-volatile memory, and sections of system memory associated with high-priority processes may be stored in volatile memory. As another example, in a fourth operating mode, the system may store sections of system memory associated with applications, processes, and/or operating systems in non-volatile memory, and the system may store sections of system memory used as a cache memory level in volatile memory. In such examples, sections of system memory may be stored in non-volatile memory and volatile memory to facilitate operating modes having various power consumption levels and various data processing speeds.

Examples adjust mappings of virtual addresses associated with the system memory based on whether the system memory is implemented in volatile memory or non-volatile memory. Mapping virtual addresses to physical memory addresses may correspond to adjusting page table entries which may be referenced by processing resources during processing of instructions. Accordingly, by adjusting page table entries (such as page table entries stored in translation look-aside buffers or in other memory locations), examples translate the virtual addresses associated with the system memory to physical memory addresses of the volatile memory or the non-volatile memory. As will be appreciated, therefore, from the perspective of processing resources, which operate in the virtual address domain, the location of the system memory does not appear to change. As such, examples may migrate system memory between different types of memory (e.g., between volatile and non-volatile memory) without modification at an instruction/processing resource level of the system.

In addition, while various examples are described herein, elements and/or combinations of elements may be combined and/or removed for various examples contemplated hereby. For example, the example operations provided herein in the flowcharts of FIGS. 5-12 may be performed sequentially, concurrently, or in a different order. Moreover, some example operations of the flowcharts may be added to other flowcharts, and/or some example operations may be removed from flowcharts. Furthermore, in some examples, various components of the example systems of FIGS. 1A-4 may be removed, and/or other components may be added. Similarly, in some examples various instructions of the example memories and/or machine-readable storage mediums of FIG. 2 may be removed, and/or other instructions may be added (such as instructions corresponding to the example operations of FIGS. 5-12).

The preceding description has been presented to illustrate and describe examples of the principles described. This description is not intended to be exhaustive or to limit examples to any precise form disclosed. Many modifications and variations are possible in light of this description.

1. A system comprising:
a non-volatile memory;
a volatile memory storing a system memory;
a memory control engine to migrate the system memory to the non-volatile memory from the volatile memory prior to the system transitioning to a first operating mode; and
a processing resource to:
process instructions using the system memory stored in the volatile memory prior to transitioning to the first operating mode, and
process instructions using the system memory stored in the non-volatile memory while the system is in the first operating mode.

2. The system of claim 1, wherein the first operating mode is a low-power mode, and the processing resource is further to:
transition the system to the low-power mode by reducing power supplied to at least one component of the volatile memory.

3. The system of claim 1, wherein the memory control engine is further to, prior to the system transitioning to a second operating mode, migrate the system memory stored in the non-volatile memory to the volatile memory, and
wherein the processing resource processes instructions using the system memory stored in the volatile memory while the system is in the second operating mode.

4. The system of claim 1, further comprising:
a memory module that comprises the volatile memory and the non-volatile memory; and
a single memory controller connected to the memory module over a single channel.

5. The system of claim 1, further comprising:
a first memory module comprising the non-volatile memory;
a second memory module comprising the volatile memory; and
a memory controller connected to the first memory module over a first channel and connected to the second memory module over a second channel.

6. The system of claim 1, further comprising:
a first memory module comprising the non-volatile memory;
a second memory module comprising the volatile memory;
a first memory controller connected to the first memory module; and
a second memory controller connected to the second memory module.

7. The system of claim 1, wherein the memory control engine is further to:
translate virtual addresses associated with the system memory to physical memory addresses of the volatile memory address prior to transitioning to the lower-power mode, and
translate virtual addresses associated with the system memory to physical memory addresses of the non-volatile memory after transitioning to the lower-power mode.

8. A method comprising:
migrating sections of system memory between volatile memory and non-volatile memory of a system based at least in part on an operating mode in which the system is determined to operate;
in a first operating mode, translating virtual addresses associated with the system memory to physical memory addresses of the non-volatile memory associated with the system memory; and
in a second operating mode, translating virtual addresses associated with the system memory to physical memory addresses of the volatile memory associated with the system memory.

9. The method of claim 8, further comprising:
in a third operating mode:
translating a first set of virtual addresses associated with a first section of the system memory to a first set of physical memory addresses of the non-volatile memory associated with the first section of the system memory; and
translating a second set of virtual addresses associated with a second section of the system memory to a second set of physical memory addresses of the volatile memory associated with the second section of the system memory.

10. The method of claim 9, wherein the first operating mode is a low-power and low-performance mode, the second operating mode is a high-power and high-performance mode, and the third operating mode is a balanced power and performance mode.

11. The method of claim 8, further comprising:
in response to migrating a particular section of the system memory to the non-volatile memory, adjusting page table entries to map virtual addresses associated with the particular section of the system memory to physical memory addresses associated with the non-volatile memory;
in the first operating mode, processing instructions with a processing resource of the system using the system memory stored in the non-volatile memory; and
in the second operating mode, processing instructions with the processing resource of the system using the system memory stored in the volatile memory.

12. The method of claim 8, further comprising:
in response to determining to operate the system in the first operating mode and after migrating the system memory to the non-volatile memory, reducing power supplied to components of the volatile memory; and
in response to determining to operate the system in the second operating mode and before migrating the system memory to the volatile memory, increasing power supplied to components of the volatile memory.

13. The method of claim 8, further comprising:
determining the operating mode in which the system is to operate based at least in part on user input, system usage characteristics, a battery level, processing performance demands, power consumption preferences, or any combination thereof.

14. A non-transitory machine-readable storage medium comprising instructions executable by a processing resource of a system to cause the system to:
in response to determining to transition the system to a lower-power mode, migrate a system memory from a volatile memory to a non-volatile memory;
after migrating the system memory from the volatile memory to the non-volatile memory, map virtual addresses associated with the system memory to physical memory addresses of the non-volatile memory;
after mapping the virtual addresses associated with the system memory to physical memory addresses of the non-volatile memory, reduce power supplied to at least one component associated with the volatile memory;
in response to determining to transition the system to a higher-performance mode, increase power supplied to the at least one component associated with the volatile memory;
after increasing power supplied to the at least one component of the volatile memory, migrate the system memory from the non-volatile memory to the volatile memory; and
after migrating the system memory from the non-volatile memory to the volatile memory, map virtual addresses associated with the system memory to physical memory addresses of the volatile memory.

15. The non-transitory machine-readable storage medium of claim 14, wherein the instructions to map the virtual addresses associated with the system memory to physical memory addresses of the non-volatile memory comprise instructions to adjust a translation-look aside buffer such that the virtual addresses associated with the system memory correspond to the physical memory addresses of the non-volatile memory.
